(19) United States
(12) Patent Application Publication
(10) Pub. No.: US 2020/0133367 A1
(43) Pub. Date: Apr. 30, 2020

(54) POWER MANAGEMENT FOR WORKLOAD OFFLOAD ENGINES

(71) Applicant: Intel Corporation, Santa Clara, CA (US)

(72) Inventors: Junyuan WANG, Shanghai (CN); Chris MACNAMARA, Limerick (IE); Liang MA, Shannon (IE); Changzheng WEI, Shanghai (CN); Ziye YANG, Shanghai (CN); Jing B. LI, Shanghai (CN); Jun XU, Shanghai (CN)

(21) Appl. No.: 16/726,679

(22) Filed: Dec. 24, 2019

Related U.S. Application Data
(60) Provisional application No. 62/791,278, filed on Jan. 11, 2019.

(51) Int. Cl. G06F 1/26; H03M 13/00; G06F 21/60

(52) U.S. Cl. CPC G06F 1/266; G05B 15/02; G06F 21/602; H03M 13/6588

(57) ABSTRACT

Examples described herein relate to allocation of power to engines and a surplus power available for use by one or more engines. A power management controller reserves power for one or more processors of the offload engine and provides a surplus power level. Based on a request for a workload performance by the first processor, the power management controller provides power to a processor based on the reserved power for the processor. Allocation of the surplus power can be made based on a priority of a workload relative to other workloads.

### RELATED APPLICATION

The present application claims the benefit of a priority date of U.S. provisional patent application Ser. No. 62/791,278, filed Jan. 11, 2019, the entire disclosure of which is incorporated herein by reference.

### DESCRIPTION

With increasing central processing unit (CPU) architecture complexity, use of accelerators (e.g. graphics processing units (GPU), field programmable gate arrays (FPGA), programmable control logic (PCL), and Intel® Quick Assist Technology (QAT)) integrated in a CPU or accessible to a CPU can allow CPU to offload time consuming or expensive operations. Accelerators such as Intel® QAT provide high performance data compression (DC) capability and cryptography services such as public key encryption (PKE), cipher, or authentication capabilities to offload the CPU's workload. For each type of service workload, QAT has corresponding hardware computing resources called a “slice” to perform a process. For example, DC service is performed by one or more DC slices, PKE service is performed by one or more PKE slices, and so forth.

### BRIEF DESCRIPTION OF THE DRAWINGS

FIG. 1 depicts an example of an offload engine integrated into a central processing unit (CPU).

FIG. 2 depicts an example of a group of slices to which power is allocated.

FIG. 3 depicts an example of power budget allocation to a variety of services.

FIG. 4 depicts an example process.

FIG. 5 depicts a system.

FIG. 6 depicts a system.

FIG. 7 depicts a system.

FIG. 8 depicts an example environment.

FIG. 9 depicts a network interface that can use embodiments or be used by embodiments.

### DETAILED DESCRIPTION

A QAT can be a Peripheral Component Interconnect Express (PCIe) plug-in card that plugs into a rack of a server. In some cases, QAT can be integrated into a central processing unit (CPU) socket. QAT and CPU core(s) can share a power controller even if positioned in different dies. When a QAT is running at high performance, QAT requires more power (e.g., current level) than when the QAT is idle or running at low performance. In some cases, if a QAT is integrated into a CPU socket, a fixed socket thermal design power (TDP) can be applied that limits socket power use. In such cases, QAT could receive a limited power budget when CPU cores are running high activity factor and the accelerator may not receive sufficient power to provide acceptable performance quality for various types of workloads. For example, when CPU cores are running applications that have a high activity factor and high CPU power, only a limited power budget will be assigned to QAT and all of this power budget could be consumed up by DC slices, thereby starving other slices such as PKE or cipher. If a QAT has a heavy DC workload, QAT can be unable to handle crypto service due to power constraints.

Some power management schemes do not guarantee power availability to multiple services availability within a limited power budget. In some instances, one type of slice could consume up all or most of power budget with a heavy workload, which makes other types of slices unable to provide service due to power constraints.

Various embodiments allocate power to slices or other processors of an offload engine. For example, a group of slices can be selected and power allocated to the group of slices. For example, a group of slices can provide a compression (DC) capability, cryptography services such as public key encryption (PKE), decryption, cipher, authentication capabilities, packet processing, or other capabilities or services. A full-power state power consumption amount can be allocated to this group of slices and reserved from the total power budget available to a socket to provide a service commitment capability that could be met even if one type of slice has a surging workload. For example, a budget of X amperes (e.g., milliamperes, microamperes, nanoamperes, and so forth) can be allocated to a CPU socket including one or multiple cores and a group of slices. During operation, a surplus power budget available after allocation of power to the one or more cores and the power allocation to the group of slices can be used to provide power to a slice. The surplus power budget can be allocated to a service according to the service's priority such that a higher priority service will receive more power budget to enable its corresponding slice. A service priority can be specified by a workload, an application or customer's configuration of the slices. For example, a compression service (and corresponding slice(s)) can be prioritized identified as having a higher priority than that of PKE services and so forth.

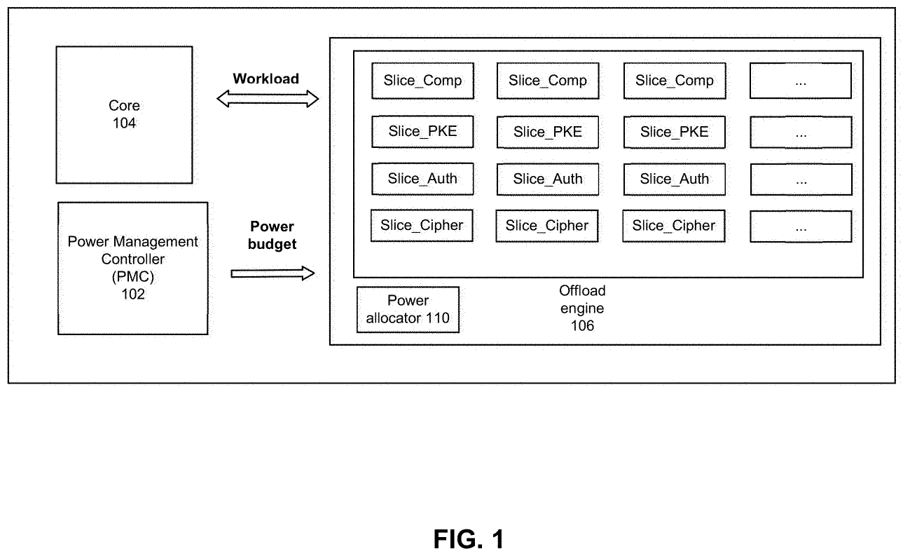

For example, FIG. 1 depicts an example of an offload engine integrated into a central processing unit (CPU) or accessible to a core through an interconnect (e.g., on a shared die), fabric, or network. Offload engine 106 can receive offloads of data cryptography or compression, PKE, authentication, or cipher workloads from core 104. Power management controller (PMC) 102 can monitor a power consumption amount, clock frequency, temperature of core 104 using polling or interrupts. PMC 102 can set a power budget for core 104 and offload engine 106. PMC 102 can control power use by offload engine 106. Per job, at time intervals, or at events, PMC 102 can assess power use needed for any slice of offload engine 106. PMC 102 can be implemented as hardware and/or processor-executed software. For example, PMC 102 can be used by a work scheduler that schedules execution of workloads or workloads of linked operations. In some examples, various processors (e.g., hardware elements and accelerators) are available for use in linked or chained operations by the work scheduler. A CPU socket can include one or more mechanical components that provide mechanical and/or electrical connections between a microprocessor or core(s) and a printed circuit board (PCB) or other circuit board. Processor sockets can use a pin grid array (PGA) such that pins on the underside of the processor connect to interfaces in the processor socket.

Offload engine 106 can include compute slices that are homogeneous or heterogeneous hardware compute units that perform data compression (DC), cryptography services such as public key encryption (PKE), encryption, decryption, cipher, authentication capabilities, packet processing, or other services. For example, offload engine 106 can provide co-processors, field programmable gate arrays (FPGAs), programmable control logic, voice recognition, image recognition, deep learning, smart network interfaces (e.g., interfaces that perform DPDK), graphics processing units (GPU), video encoders, video decoders, audio coders, audio decoders, graphics image generation, and so forth.

Core 104 can provide a workload and its parameters (service type (e.g., data compression, PKE, Auth, and cipher), priority of service, source/destination memory address for direct memory access, and so forth) to offload engine 106. One or more types of workloads can be requested in parallel or serially. Based on allocated power from PMC 102, power allocator 110 can allocate power to corresponding slices of offload engine 106 in response to provisioning of a workload by core 104 using a slice or slices. In this example, power allocator 110 receives an indication of the power budget for a slice and a surplus power amount. Power allocator 110 can determine which slice to allocate power to, based on priority of workload requests from core 104.

A slice can provide services implemented by hardware or specific functions or processes executed by processors. For example, a slice can include processors and memory. Processors can include accelerators, a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). A processor can perform packet processing such as one or more of: firewalling, flow classification, TCP termination, Address Resolution Protocol (ARP), access control list, routing service function chains (firewall, access control, decapsulation, packet processing), firewall, email server, Domain Name System (DNS), virtual private network (VPN), backup and remote file sharing.

A slice changes power state from clock-gated to full-power when corresponding type of workload is loaded and is to be performed by the slice. After the slice completes workload processing, the power state of the slice changes from full-power to clock-gated to save power. In some cases, instead of using clock-gating, power gating can be used to remove or reduce power (e.g., current) provided to a slice. Offload engine 106 can provide results of a workload into a memory (volatile or non-volatile) or cache (not depicted) accessible by core 104. One or more cores can share use of offload engine 106 or access results from offload engine 106.

For example, PMC 102 can allocate a 10 A budget for offload engine 106 and provide 2 A for cryptography, 2 A for compression, 2 A for PKE, with 4 A surplus available to be dynamically allocated to active high priority services (and corresponding slice(s)). For example, if a request is received to perform cryptography (e.g., encryption), 2 A of power can be allocated for cryptography. If additional cryptography service requests are received, then some or none of the 4 A surplus can be allocated to perform the cryptography service requests using one or more cryptography slices. As another example, if core 104 performs processes that require additional power, power allocator 110 can allocate some or none of the 4 A surplus power for use by core 104. Based on a priority of workload specified by core 104, power allocator 110 can prioritize requests for additional power from core 104 over allocation of surplus power to any slice in offload engine 106. In some examples, if a workload has a higher priority than a second workload that uses surplus power and performance of the workload is to use surplus power, if insufficient surplus power is available for use to perform the workload, surplus power is de-allocated from use to perform the second workload and allocated to perform the workload.

For example a connection among PMC 102, core 104, and offload engine 106 can use any of: Ethernet (IEEE 802.3), remote direct memory access (RDMA), InfiniBand, Internet Wide Area RDMA Protocol (iWARP), quick UDP Internet Connections (QUIC), RDMA over Converged Ethernet (RoCE), Peripheral Component Interconnect (PCIe), Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, any memory interface standard (e.g., DDR4 or DDR5), and variations thereof.

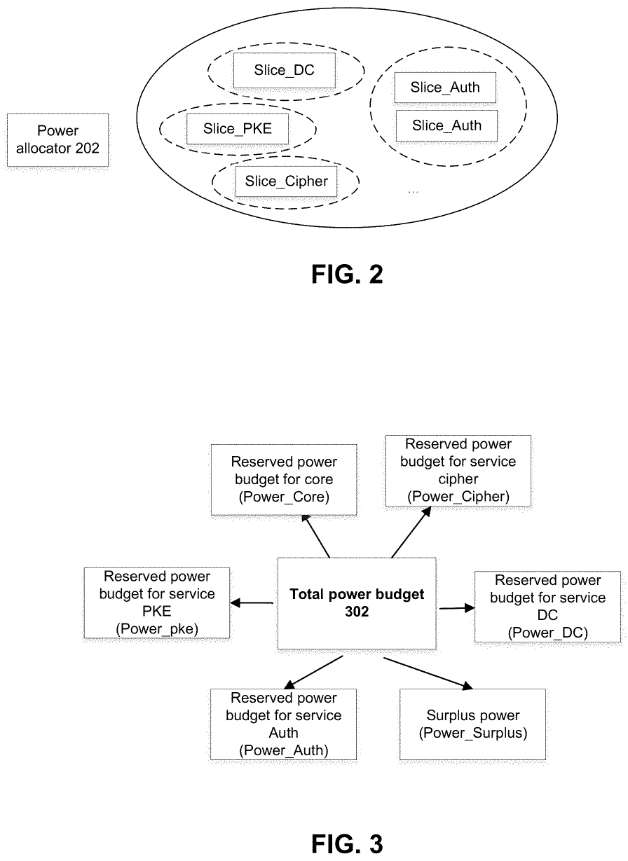

FIG. 2 depicts an example of a group of slices, to which power is allocated. In this example depiction, power is allocated for a data compression (DC) slice, a public key encryption (PKE) slice, a cipher slice, and two authentication slices. An operating system, virtual execution environment, or application that uses a core and offload engine can allocate the power for the slices. In another example, an administrator or owner of a CPU and offload engine can allocate the power to a core and slices of the offload engine.

A virtualized execution environment can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can be an OS or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from each other, allowing virtual machines to run Linux® and Windows® Server operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers are not installed like traditional software programs, which allows them to be isolated from the other software and the operating system itself. Isolation can include permitted access of a region of addressable memory or storage by a particular container but not another container. The isolated nature of containers provides several benefits. First, the software in a container will run the same in different environments. For example, a container that includes PHP and MySQL can run identically on both a Linux computer and a Windows machine. Second, containers provide added security since the software will not affect the host operating system. While an installed application may alter system settings and modify resources, such as the Windows registry, a container can only modify settings within the container.

For example, if a workload request is received for a service to be performed by a DC slice, power allocator 202 permits the allocated power to be provided to the DC slice to perform the workload request. For example, if a workload request is received for a service to be performed by an authentication slice, power allocator 202 permits the allocated power to be provided to an authentication slice to perform the workload request. If an additional authentication slice is needed to be allocated to perform the authentication workload request or another authentication workload request is received at the offload engine, power allocator 202 permits allocated power from the power surplus to be provided to the additional authentication slice to perform the workload request. If various workload require additional power allocations, power allocator 202 can choose a power amount from surplus power to allocate to a service/slice based on workload priority specified by the core. Various techniques can be used to allocate a workload for execution by multiple slices.

FIG. 3 depicts an example of power budget allocation to a variety of services. A total power budget 302 available can be a sum of the power reserved for the slices, power reserved for a core, and a surplus power. Variable Power_Cipher can represent a power reserved for use by a cipher service. Variable Power_PKE can represent a power budget reserved for service PKE. Variable Power_Auth can represent a power reserved for authentication services. Variable Power_DC can represent reserved power budget for a data compression service. Variable Power_Core can represent power budget reserved for a core. Variable Power_Surplus can represent an available surplus power that could be allocated to any service or a core or cores.

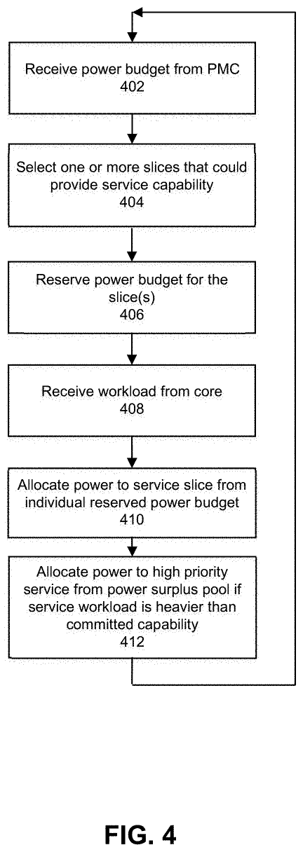

FIG. 4 depicts an example process. The process can be performed by a power allocator that allocates power to slices or processors. At 402, a power budget can be received from a power management controller (PMC) for use by an offload engine. The offload engine can receive its power budget from the PMC. At 404, a slice subset can be selected to provide a service capability. For example, some slices are configured to perform description, other slices are configured to perform packet processing, and some slices are unallocated and not configured currently to perform processing. At 406, power budget can be reserved for the selected slice(s). Actions 404 and 406 can be repeated for all slice subsets to reserve a power budget for each slice subset with an allocated power budget. One or more of each slice group can have power reserved. For example, when slices can perform data compression (DC), a public key encryption (PKE), cipher, and authentication, power can be reserved for at least one slice of DC, PKE, cipher, and authentication. However, power can be reserved for any of the slices even if not all types of slices (e.g., DC, PKE, cipher, and authentication) are allocated reserved power. Power reserved for each type of slice can be specified by an application or administrator. The power reserved can be changed for each type of workload and provided at the same time or prior to when a workload is received at the offload engine. For this example, a total power budget for the offload engine can be: Total power budget=Power_Cipher+Power_PKE+Power_Auth+Power_DC+Power_Surplus. After receipt of a power budget for the selected one or more slices, the selected one or more slices's power state can be changed to clock-gated in a service idle state.

At 408, a workload request can be received from a core. The core can be local or remote from the offload engine. In some cases, the core is part of a workload scheduler. For example, an offload engine can receive the workload request from the core. The workload request can specify a slice and parameters for performance of the workload request. In some examples, the workload request indicates a workload but not a particular slice, and the slice can be allocated to perform the workload by the offload engine.

At 410, power is allocated to a service slice from the individual reserved power budget. For example, if a workload request is for use of a particular slice, that slice is allocated its reserved power budget. For example, if a workload request requires a DC service, then one or more DC slices can be selected to perform the workload request. In response to receipt of a workload, power can be allocated from an individual reserved power budget to change a slice's power state to full-power to perform data processing.

At 412, power is allocated to the higher priority services from a power surplus pool if the service workload is heavier than the committed capability of the slice. For example, if a service workload needs more service level or performance commitment than that offered by the slice, then power surplus can be used to allocate power to the slice or an additional slice. The additional slice can consume the same power budget as the other slice of the same type. For one specific type of service workload, if the power consumption is larger than its reserved power budget allocated, power can be allocated from a power surplus budget according to service priority. A higher priority service can receive power from the surplus power budget before a lower priority service to ensure the performance requirements of the workload (e.g., priority) are met.

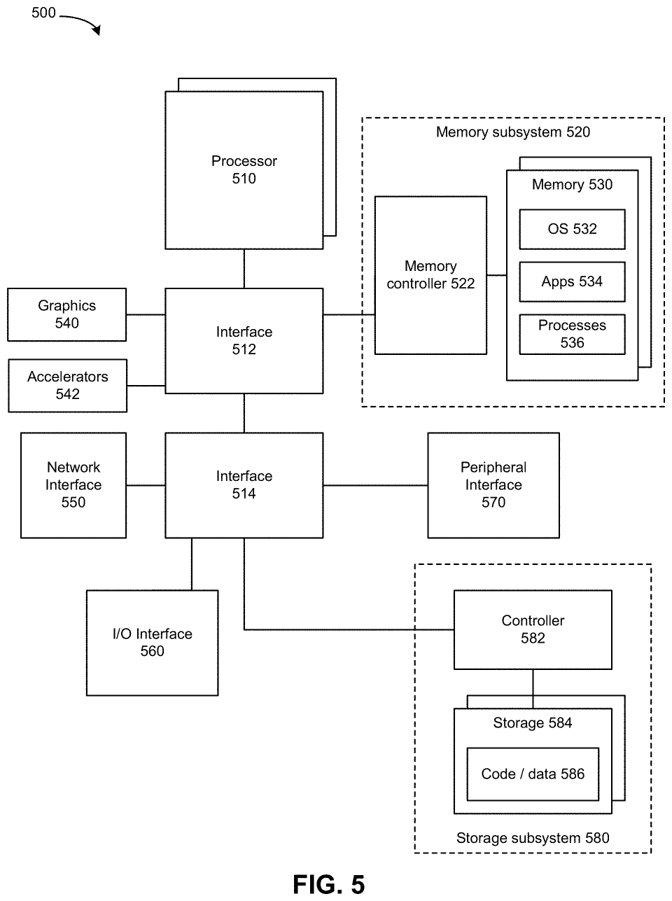

FIG. 5 depicts an example system. The system can use embodiments described herein to allocate power to any device including graphics 540 or accelerators 542. System 500 includes processor 510, which provides processing, operation management, and execution of instructions for system 500. Processor 510 can include any type of microprocessor, central processing unit (CPU), graphics processing unit (GPU), processing core, or other processing hardware to provide processing for system 500, or a combination of processors. Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be a fixed function offload engine that can be accessed or used by a processor 510. For example, an accelerator among accelerators 542 can provide compression (DC) capability, cryptography services such as public key encryption (PKE), cipher, hash/authentication capabilities, decryption, or other capabilities or services. In some embodiments, in addition or alternatively, an accelerator among accelerators 542 provides field select controller capabilities as described herein. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 542 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory. Network interface 550 can receive data from a remote device, which can include storing received data into memory. Various embodiments can be used in connection with network interface 550, processor 510, and memory subsystem 520.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (i.e., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (i.e., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 500. More specifically, power source typically interfaces to one or multiple power supplies in system 500 to provide power to the components of system 500. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 500 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (i.e., buses) for coupling appropriate integrated circuits (ICs) and other components mounted to the board.

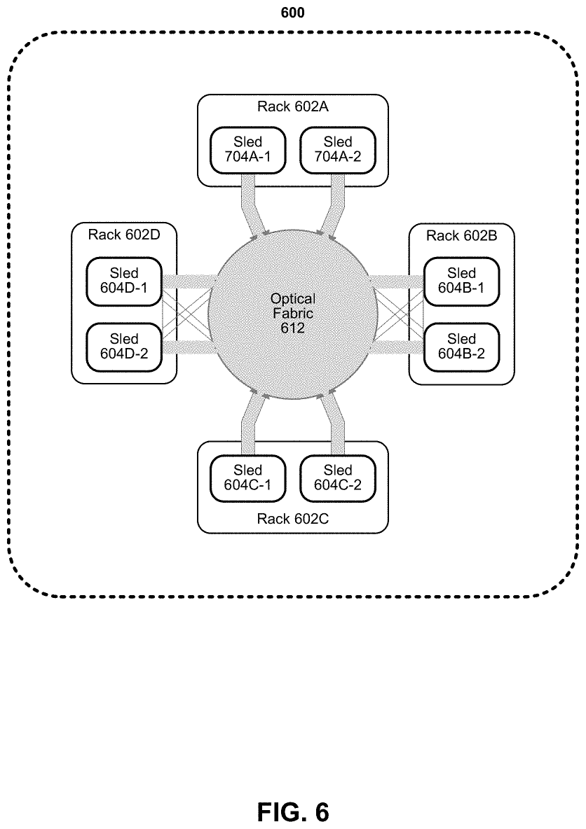

FIG. 6 depicts an example of a data center. As shown in FIG. 6, data center 600 may include an optical fabric 612. Optical fabric 612 may generally include a combination of optical signaling media (such as optical cabling) and optical switching infrastructure via which any particular sled in data center 600 can send signals to (and receive signals from) each of the other sleds in data center 600. The signaling connectivity that optical fabric 612 provides to any given sled may include connectivity both to other sleds in a same rack and sleds in other racks. Data center 600 includes four racks 602A to 602D and racks 602A to 602D house respective pairs of sleds 604A-1 and 604A-2, 604B-1 and 604B-2, 604C-1 and 604C-2, and 604D-1 and 604D-2. Thus, in this example, data center 600 includes a total of eight sleds. Optical fabric 612 can provide each sled signaling connectivity with one or more of the seven other sleds. For example, via optical fabric 612, sled 604A-1 in rack 602A may possess signaling connectivity with sled 604A-2 in rack 602A, as well as the six other sleds 604B-1, 604B-2, 604C-1, 604C-2, 604D-1, and 604D-2 that are distributed among the other racks 602B, 602C, and 602D of data center 600. The embodiments are not limited to this example.

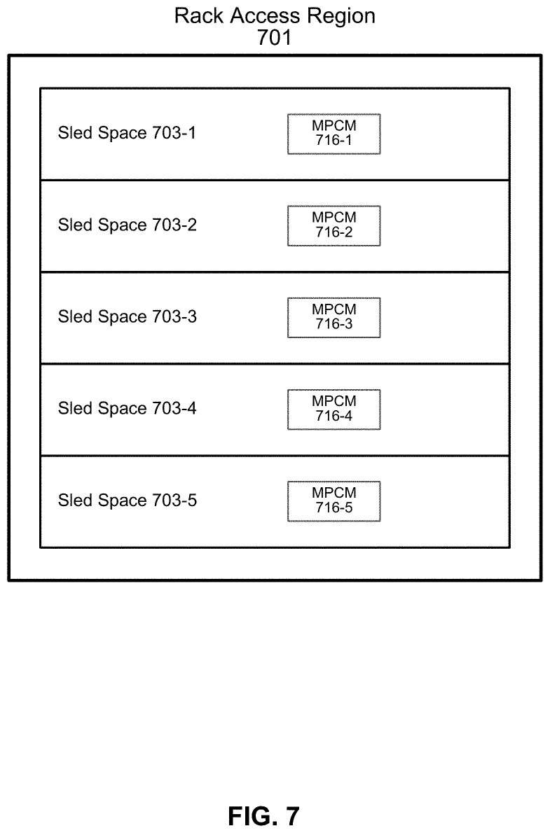

FIG. 7 depicts a rack architecture such that a plurality of sled spaces can have sleds inserted. Sled spaces can be robotically-accessible via a rack access region 701. In the particular non-limiting example, rack architecture 700 features five sled spaces 703-1 to 703-5. Sled spaces 703-1 to 703-5 feature respective multi-purpose connector modules (MPCMs) 716-1 to 716-5.

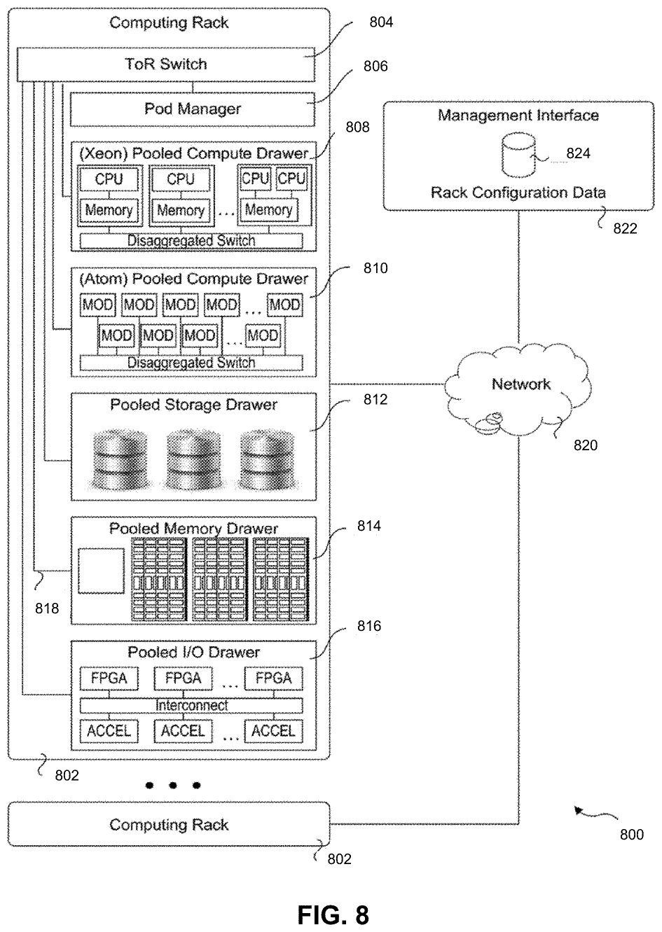

FIG. 8 depicts an environment 800 includes multiple computing racks 802, each including a Top of Rack (ToR) switch 804, a pod manager 806, and a plurality of pooled system drawers. Various embodiments can be used in a switch. Generally, the pooled system drawers may include pooled compute drawers and pooled storage drawers. Optionally, the pooled system drawers may also include pooled memory drawers and pooled Input/Output (I/O) drawers. In the illustrated embodiment the pooled system drawers include an Intel® XEON® pooled computer drawer 808, and Intel® ATOM™ pooled compute drawer 810, a pooled storage drawer 812, a pooled memory drawer 814, and a pooled I/O drawer 816. Each of the pooled system drawers is connected to ToR switch 804 via a high-speed link 818, such as a 40 Gigabit/second (Gb/s) or 100 Gb/s Ethernet link or a 100+Gb/s Silicon Photonics (SiPh) optical link. In one embodiment high-speed link 818 comprises an 800 Gb/s SiPh optical link.

Multiple of the computing racks 802 may be interconnected via their ToR switches 804 (e.g., to a pod-level switch or data center switch), as illustrated by connections to a network 820. In some embodiments, groups of computing racks 802 are managed as separate pods via pod manager(s) 806. In one embodiment, a single pod manager is used to manage all of the racks in the pod. Alternatively, distributed pod managers may be used for pod management operations.

Environment 800 further includes a management interface 822 that is used to manage various aspects of the environment. This includes managing rack configuration, with corresponding parameters stored as rack configuration data 824.

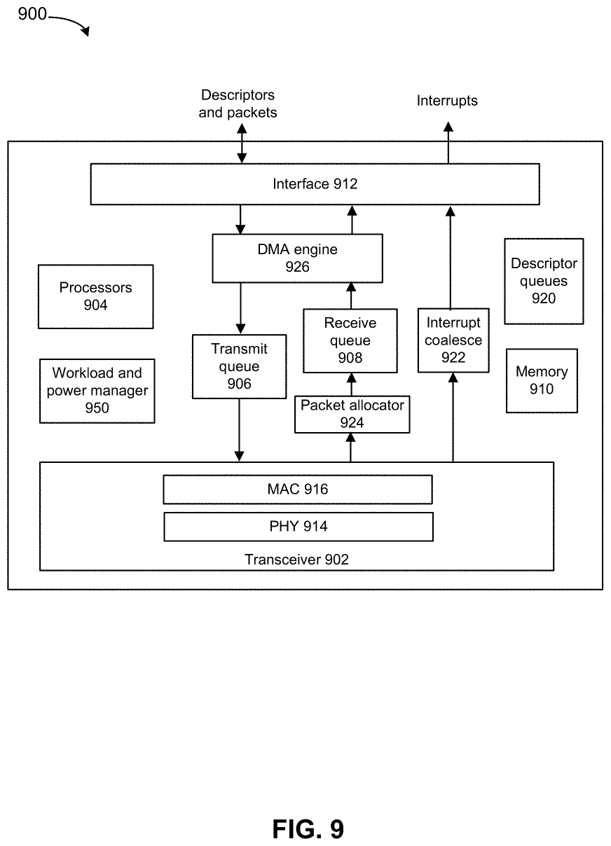

FIG. 9 depicts a network interface that can use embodiments or be used by embodiments. Various processors of network interface 900 can use techniques described herein to request workload performance and allocate power to performance of workloads. Network interface 900 can include transceiver 902, processors 904, transmit queue 906, receive queue 908, memory 910, and bus interface 912, and DMA engine 926. Transceiver 902 can be capable of receiving and transmitting packets in conformance with the applicable protocols such as Ethernet as described in IEEE 802.3, although other protocols may be used. Transceiver 902 can receive and transmit packets from and to a network via a network medium (not depicted). Transceiver 902 can include physical layer (PHY) circuitry 914 and media access control (MAC) circuitry 916. PHY circuitry 914 can include encoding and decoding circuitry (not shown) to encode and decode data packets according to applicable physical layer specifications or standards. MAC circuitry 916 can be configured to assemble data to be transmitted into packets, that include destination and source addresses along with network control information and error detection hash values. MAC circuitry 916 can be configured to process MAC headers of received packets by verifying data integrity, removing preambles and padding, and providing packet content for processing by higher layers.

Processors 904 can be any a combination of a: processor, core, graphics processing unit (GPU), field programmable gate array (FPGA), application specific integrated circuit (ASIC), or other programmable hardware device that allow programming of network interface 900. For example, processors 904 can provide for allocation or deallocation of intermediate queues. For example, a “smart network interface” can provide packet processing capabilities in the network interface using processors 904.

Packet allocator 924 can provide distribution of received packets for processing by multiple CPUs or cores using timeslot allocation described herein or RSS. When packet allocator 924 uses RSS, packet allocator 924 can calculate a hash or make another determination based on contents of a received packet to determine which CPU or core is to process a packet.

Interrupt coalesce 922 can perform interrupt moderation whereby network interface interrupt coalesce 922 waits for multiple packets to arrive, or for a time-out to expire, before generating an interrupt to host system to process received packet(s). Receive Segment Coalescing (RSC) can be performed by network interface 900 whereby portions of incoming packets are combined into segments of a packet. Network interface 900 provides this coalesced packet to an application.

Direct memory access (DMA) engine 926 can copy a packet header, packet payload, and/or descriptor directly from host memory to the network interface or vice versa, instead of copying the packet to an intermediate buffer at the host and then using another copy operation from the intermediate buffer to the destination buffer.

Memory 910 can be any type of volatile or non-volatile memory device and can store any queue or instructions used to program network interface 900. Transmit queue 906 can include data or references to data for transmission by network interface. Receive queue 908 can include data or references to data that was received by network interface from a network. Descriptor queues 920 can include descriptors that reference data or packets in transmit queue 906 or receive queue 908. Bus interface 912 can provide an interface with host device (not depicted). For example, bus interface 912 can be compatible with peripheral connect Peripheral Component Interconnect (PCI), PCI Express, PCI-x, Serial ATA (SATA), and/or Universal Serial Bus (USB) compatible interface (although other interconnection standards may be used).

In accordance at least with embodiments described herein, workload and power manager 950 can request performance of jobs on processors 904 network interface or in a separate device (e.g., an offload engine or accelerator accessible through an interconnect, fabric, or network in the same or different data center) and manage power use by devices that perform jobs.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” “logic,” “circuit,” or “circuitry.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes an apparatus that includes a memory and a power management controller to: allocate a reserve power for one or more processors of an offload engine, wherein the one or more processors include a first processor; reserve a surplus power level; and in response to a request for a workload performance by the first processor, provide power to the first processor based on the reserve power for the first processor.

Example 2 includes any example, and includes an offload engine comprising one or more processors and a power allocator, wherein: in response to a request for the workload performance involving power use of the first processor exceeding associated reserved power, the power allocator is to allocate additional power for the first processor from the surplus power level.

Example 3 includes any example, and includes an offload engine comprising one or more processors and a power allocator, wherein the power allocator is to prioritize power allocation using the surplus power level based at least on priority of a workload.

Example 4 includes any example and includes an offload engine comprising one or more processors and a power allocator, wherein: the power allocator is to allocate power for a second processor of the one or more processors from the surplus power level.

Example 5 includes any example and includes an offload engine, wherein a total power budget allocated to the offload engine includes power reserved for the one or more processors of the offload engine and the surplus power level.

Example 6 includes any example and includes an offload engine, wherein the one or more processors of the offload engine are to perform one or more of: data compression (DC), a public key encryption (PKE), cipher, or authentication.

Example 7 includes any example and includes an offload engine and a processor core communicatively coupled to the offload engine, wherein the processor core is to provide the request for a workload performance to the offload engine.

Example 8 includes any example and includes an offload engine, wherein the offload engine and the power management controller are provided in one or more of: a compute sled, data center, server, rack, or blade.

Example 9 includes any example and includes an offload engine, wherein the offload engine comprises Quick Assist Technology (QAT) comprising: at least one slice to perform data compression (DC), at least one slice to perform cryptography services including public key encryption (PKE), at least one slice to perform a cipher activity, at least one slice to perform authentication, and the power allocator is to allocate power to one or more of: at least one slice to perform DC, at least one slice to perform cryptography services including PKE, at least one slice to perform cipher, and at least one slice to perform authentication.

Example 10 includes a method that includes: receiving a power allocation comprising a surplus power; receiving a request to perform a workload; allocating power to a first processor based on the power allocation, the first processor to perform a portion of the workload; and allocating power to a second processor from the surplus power, the second processor to perform a second portion of the workload.

Example 11 includes any example, wherein a workload comprises: a service type, priority of service, source memory address, and destination memory address.

Example 12 includes any example, wherein the service type comprises one or more of: data compression, data decompression, packet processing, or public key encryption (PKE).

Example 13 includes any example, wherein the first processor and the second processor comprise one or more of: at least one slice to perform data compression (DC), at least one slice to perform cryptography services including public key encryption (PKE), at least one slice to perform cipher, or at least one slice to perform authentication.

Example 14 includes any example and includes: receiving a request to perform a second workload and allocating power for a third processor to perform the second workload from the power allocation.

Example 15 includes any example and includes determining additional power is needed by the third processor to perform the second workload and based on the second workload having a higher priority level than the workload, allocating additional power from the surplus power to the third processor and de-allocating power from the surplus power to the second processor.

Example 16 includes any example and includes prioritizing power allocation using the surplus power based on priority of the workload relative to other workloads that are to use the surplus power.

Example 17 includes a computer-readable medium comprising instructions stored thereon, that if executed, cause one or more processors to: reserve power for one or more processors; reserve a surplus power level; and in response to a request for a workload performance by a processor, provide power to the processor based on a reserved power for the processor.

Example 18 includes any example and includes instructions stored thereon, that if executed, cause one or more processors to: in response to a request for the workload performance involving power use of the processor being exceeded, allocating additional power to the processor from the surplus power level.

Example 19 includes any example and includes instructions stored thereon, that if executed, cause one or more processors to: prioritize power allocation from the surplus power level based on priority of the workload relative to other workloads that are to use the surplus power level.

Example 20 includes any example, wherein the one or more processors are to perform one or more of: data compression (DC), a public key encryption (PKE), cipher, or authentication.

What is claimed is:

1. An apparatus comprising:
a memory and
a power management controller to:
allocate a reserve power for one or more processors of an offload engine, wherein the one or more processors include a first processor;
reserve a surplus power level; and
in response to a request for a workload performance by the first processor, provide power to the first processor based on the reserve power for the first processor.

2. The apparatus of claim 1, further comprising an offload engine comprising one or more processors and a power allocator, wherein:
in response to a request for the workload performance involving power use of the first processor exceeding associated reserved power, the power allocator is to allocate additional power for the first processor from the surplus power level.

3. The apparatus of claim 1, further comprising an offload engine comprising one or more processors and a power allocator, wherein the power allocator is to prioritize power allocation using the surplus power level based at least on priority of a workload.

4. The apparatus of claim 1, further comprising an offload engine comprising one or more processors and a power allocator, wherein:
the power allocator is to allocate power for a second processor of the one or more processors from the surplus power level.

5. The apparatus of claim 1, further comprising an offload engine, wherein a total power budget allocated to the offload engine includes power reserved for the one or more processors of the offload engine and the surplus power level.

6. The apparatus of claim 1, further comprising an offload engine, wherein the one or more processors of the offload engine are to perform one or more of: data compression (DC), a public key encryption (PKE), cipher, or authentication.

7. The apparatus of claim 1, further comprising an offload engine and further comprising a processor core communicatively coupled to the offload engine, wherein the processor core is to provide the request for a workload performance to the offload engine.

8. The apparatus of claim 1, further comprising an offload engine, wherein the offload engine and the power management controller are provided in one or more of: a compute sled, data center, server, rack, or blade.

9. The apparatus of claim 1, further comprising an offload engine, wherein the offload engine comprises Quick Assist Technology (QAT) comprising:
at least one slice to perform data compression (DC),
at least one slice to perform cryptography services including public key encryption (PKE),
at least one slice to perform a cipher activity,
at least one slice to perform authentication, and
the power allocator is to allocate power to one or more of: at least one slice to perform DC, at least one slice to perform cryptography services including PKE, at least one slice to perform cipher, and at least one slice to perform authentication.

10. A method comprising:
receiving a power allocation comprising a surplus power;
receiving a request to perform a workload;
allocating power to a first processor based on the power allocation, the first processor to perform a portion of the workload; and
allocating power to a second processor from the surplus power, the second processor to perform a second portion of the workload.

11. The method of claim 10, wherein a workload comprises: a service type, priority of service, source memory address, and destination memory address.

12. The method of claim 11, wherein the service type comprises one or more of: data compression, data decompression, packet processing, or public key encryption (PKE).

13. The method of claim 10, wherein the first processor and the second processor comprise one or more of: at least one slice to perform data compression (DC), at least one slice to perform cryptography services including public key encryption (PKE), at least one slice to perform cipher, or at least one slice to perform authentication.

14. The method of claim 10, comprising:
receiving a request to perform a second workload and
allocating power for a third processor to perform the second workload from the power allocation.

15. The method of claim 14, comprising:
determining additional power is needed by the third processor to perform the second workload and
based on the second workload having a higher priority level than the workload, allocating additional power from the surplus power to the third processor and de-allocating power from the surplus power to the second processor.

16. The method of claim 10, comprising:
prioritizing power allocation using the surplus power based on priority of the workload relative to other workloads that are to use the surplus power.

17. A computer-readable medium comprising instructions stored thereon, that if executed, cause one or more processors to:
reserve power for one or more processors;
reserve a surplus power level; and
in response to a request for a workload performance by a processor, provide power to the processor based on a reserved power for the processor.

18. The computer-readable medium of claim 17, comprising instructions stored thereon, that if executed, cause one or more processors to:
in response to a request for the workload performance involving power use of the processor being exceeded, allocating additional power to the processor from the surplus power level.

19. The computer-readable medium of claim 17, comprising instructions stored thereon, that if executed, cause one or more processors to:
prioritize power allocation from the surplus power level based on priority of the workload relative to other workloads that are to use the surplus power level.

20. The computer-readable medium of claim 17, wherein the one or more processors are to perform one or more of: data compression (DC), a public key encryption (PKE), cipher, or authentication.
